(19) United States
(12) Patent Application Publication
(10) Pub. No.: US 2008/0055340 A1
(43) Pub. Date: Mar. 6, 2008

(54) DISPLAY APPARATUS INCLUDING OPTICAL MODULATOR AND IMAGE CONTROLLING METHOD

(75) Inventors: In-Jae Yeo, Yongin-si (KR); Seung-Won Ryu, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/849,111

(22) Filed: Aug. 31, 2007

(30) Foreign Application Priority Data
Sep. 1, 2006 (KR) 10-2006-0084386

(51) Int. Cl. G09G 5/10

(52) U.S. Cl. 345/690

(57) ABSTRACT

An aspect of the present invention features a display apparatus. The apparatus can comprise: an optical modulator that modulates brightness of the incident light from a light source corresponding to a driving voltage and outputs the modulated light; a driver integrated circuit that supplies a driving voltage according to an image control signal to the optical modulator; a scanner that projects the modulated light to a position on a screen; and an image control circuit that generates and outputs the image control signal from an input image signal for reducing influence of drive characteristics of the optical modulator. An image control circuit and a display apparatus according to the present invention can reflect drive characteristics of a micromirror of an optical modulator to output grayscale data corrected by using grayscale data outputted already and grayscale data desired to be outputted at now, thereby displaying purposed grayscale.

### CROSS-REFERENCE TO RELATED APPLICATIONS

This application claims the benefit of Korean Patent Application No. 10-2006-0084386 filed with the Korean Intellectual Property Office on Sep. 01, 2006, the disclosures of which are incorporated herein by reference in their entirety.

### BACKGROUND

1. Technical Field

The present invention relates to an optical modulator, more particularly to an image control circuit that compensates an error associated with drive characteristics of the 2nd order system of the optical modulator and an image control method.

2. Description of the Related Art

With the development of display technology, a demand for displaying on a large screen apparatuses has increased day by day.

Most of current large screen display apparatuses (mainly projectors) use a liquid crystal as an optical switch since a liquid crystal projector is small, inexpensive and composed of a simple optical system, compared to the conventional cathode-ray tube (CRT) projector.

But, since light is projected onto a screen through a liquid crystal plate from a light source, it causes a lot of optical loss. In order to obtain a brighter image, a micromachine such as an optical modulator, which uses reflection, can be applied to reduce the optical loss.

The micromachine refers to a machine which is so miniaturized as to be invisible with naked eyes. That can be also called a micro electro mechanical system (MEMS), and is manufactured by using semiconductor manufacturing technology.

These micromachines are applied to a variety of information devices such as a magnetic and optical head by using a micro optics and a nano device, and are also applied to a biomedical field and a semiconductor manufacturing process by using various micro fluid control technologies.

The micromachines can be classified into a micro sensor, a micro actuator and a miniature machine depending on their function.

The MEMS is applied to the optical science field as one of its applications. Using micromachining technology, optical components smaller than 1 mm can be fabricated, by which micro optical systems can be implemented.

Micro optical systems including an optical modulator element, a micro lens and the like have been currently selected and applied in telecommunication devices and information display and recording devices, due to such advantages as quick response time, low level of loss, and convenience in layering and digitalizing.

A spatial optical modulator (SOM), which is used for a scanning display apparatus, is composed of a driver integrated circuit and a plurality of micromirrors. A pixel in a projection image is displayed by one or more micromirrors.

In order to control optical intensity of the pixel, displacement of the micromirror is changed corresponding to driving voltage supplied by the driver integrated circuit, thereby changing the quantity of modulated light. Here, the driver integrated circuit generates the driving voltage in a predetermined relationship with an input signal.

The micromirror of the optical modulator has a drive characteristic that, in a very short time during the driving voltage supplied to the micromirror is changed from a first voltage to a second voltage, the characteristic of the drive displacement has a superpose of a response characteristic of the 2nd order system, of which Q factor is less than 0.707, and a response characteristic of a square wave.

Therefore, in the case of converting directly an original grayscale value of an image signal to the driving voltage for driving the micromirror of the optical modulator, the drive characteristic is reflected in the quantity of the modulated light to cause an error. Here, the error is changed with time.

### SUMMARY

The present invention provides an image control circuit and a display apparatus that reflects drive characteristics of a micromirror of an optical modulator to output grayscale data corrected by using grayscale data outputted already and grayscale data desired to be outputted at now, thereby displaying purposed grayscale.

And, the present invention provides an image control circuit and a display apparatus that, using a simple logic, can correct an error associated with drive characteristics of a micromirror of an optical modulator.

An aspect of the present invention features a display apparatus. The apparatus can comprise: an optical modulator that modulates brightness of the incident light from a light source corresponding to a driving voltage and outputs the modulated light; a driver integrated circuit that supplies a driving voltage according to an image control signal to the optical modulator; a scanner that projects the modulated light to a position on a screen; and an image control circuit that generates and outputs the image control signal from an input image signal for reducing influence of drive characteristics of the optical modulator.

The image control circuit can comprise a drive characteristic correcting part that outputs a corrected grayscale value where an original grayscale value from the input image signal and a drive characteristic coefficient of the optical modulator are reflected; and an image processing part that outputs to the driver integrated circuit the image control signal in order to project the modulated light with brightness corresponding to the corrected grayscale value, the image control signal configured to supply the driving voltage predetermined by a lookup table including relation between the driving voltage and the brightness to the optical modulator.

The drive characteristic correcting part can determine the corrected grayscale value by using the original grayscale value at a present pixel time, the original grayscale values at previous pixel times, and a drive characteristic coefficient of the optical modulator with the passage of time.

The drive characteristic coefficient can be a constant value for all pixels.

The corrected grayscale value can be calculated by the following Equation 1.

BinOUT[N][k]=BinIN[N][k]+E0×(BinIN[N][k]−BinIN[N][k−1])+E1×(BinIN[N][k−1]−BinIN[N][k−2])+ . . . +Ep×(BinIN[N][k−p]−BinIN[N][k−p−1])−Here, BinOUT[N][k] is the corrected grayscale value, BinIN[N][k] is the original grayscale value, N is a position of the pixel, k is the present pixel time, p<k, E0, E1, . . . , Ep is the drive characteristic coefficient between −1 and 1−. [Equation 1]

The modulated light of the optical modulator according to the corrected grayscale value can have average brightness corresponding to the original grayscale value during one pixel time.

Another aspect of the present invention features an image control method for minimizing influence of drive characteristics of an optical modulator in a display apparatus which includes the optical modulator that modulates brightness of incident light from the light source according to inputted driving voltage and outputs the modulated light, and a driver integrated circuit that provides to the optical modulator driving voltage corresponding to a image control signal. The method can comprise: generating a corrected grayscale value by using an original grayscale value extracted from an inputted image signal and a drive characteristic coefficient according to the drive characteristics of the optical modulator; generating an image control signal for allowing the modulated light to have brightness corresponding to the corrected grayscale value; and outputting the image control signal to the driver integrated circuit.

In the generating the corrected grayscale value, the corrected grayscale value can be determined by using an original grayscale value at a present pixel time and an original grayscale values at previous pixel times, and a drive characteristic coefficient of the optical modulator with the passage of time.

The corrected grayscale value can be calculated by the following Equation 2.

BinOUT[N][k]=BinIN[N][k]+E0×(BinIN[N][k]−BinIN[N][k−1])+E1×(BinIN[N][k−1]−BinIN[N][k−2])+ . . . +Ep×(BinIN[N][k−p]−BinIN[N][k−p−1])−Here, BinOUT[N][k] is the corrected grayscale value, BinIN[N][k] is the original grayscale value, N is a position of the pixel, k is the present pixel time, p<k, E0, E1, . . . , Ep is the drive characteristic coefficient between −1 and 1−. [Equation 2]

Additional aspects and advantages of the present general inventive concept will be set forth in part in the description which follows, and in part will be obvious from the description, or may be learned by practice of the general inventive concept.

### BRIEF DESCRIPTION OF THE DRAWINGS

These and other features, aspects, and advantages of the present invention will become better understood with regard to the following description, appended claims, and accompanying drawings where:

FIG. 1a is a perspective view of a micromirror of an optical modulator using a piezoelectric element applicable to an embodiment of the invention.

FIG. 1b is a perspective view of a micromirror of another optical modulator using a piezoelectric element applicable to an embodiment of the invention.

FIG. 1c is a plan view of an optical modulator containing a plurality of micromirrors illustrated in FIG. 1a.

FIG. 1d is a schematic diagram illustrating an image generated on a screen by means of a diffraction type optical modulator array applicable to an embodiment of the present invention.

FIG. 2 illustrates a configuration of a display apparatus where a drive characteristic of an optical modulator, in accordance with an embodiment of the present invention, is reflected.

FIG. 3 shows driving voltage supplied to each micromirror of the optical modulator, driving displacement, and brightness of a pixel according to them.

FIG. 4 is a block diagram of the image control circuit according to an embodiment of the present invention.

FIG. 5 shows output timing for displaying a frame image according to an embodiment of the present invention.

FIG. 6 shows the drive displacement and the pixel brightness in the pixel according to an embodiment of the present invention.

FIG. 7 shows the drive displacement and the pixel brightness in the pixel according to another embodiment of the present invention.

FIG. 8 is a flowchart illustrating a method of image-controlling in an image control circuit according to an embodiment of the present invention.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

An optical modulator applied to the present invention will first be described before discussing embodiments of the present invention.

The optical modulator is mainly divided into a direct type, which directly controls the on/off state of light, and an indirect type, which uses reflection and diffraction. The indirect type may be further divided into an electrostatic type and a piezoelectric type. The optical modulators are applicable to the embodiments of the invention regardless of the operation type.

An electrostatic type grating optical modulator as disclosed in U.S. Pat. No. 5,311,360 includes a plurality of equally spaced deformable reflective ribbons having reflective surfaces and suspended above an upper part of the substrate.

First, an insulation layer is deposited onto a silicon substrate, followed by depositions of a sacrificial silicon dioxide film and a silicon nitride film. The silicon nitride film is patterned with the ribbons, and some portions of the silicon dioxide film are etched so that the ribbons are maintained by a nitride frame on an oxide spacer layer.

The grating amplitude, of such a modulator limited to the vertical distance d between the reflective surfaces of the ribbons and the reflective surface of the substrate, is controlled by supplying a voltage between the ribbons (the reflective surface of the ribbon, which acts as a first electrode) and the substrate (the conductive film at the bottom portion of the substrate, which acts as a second electrode).

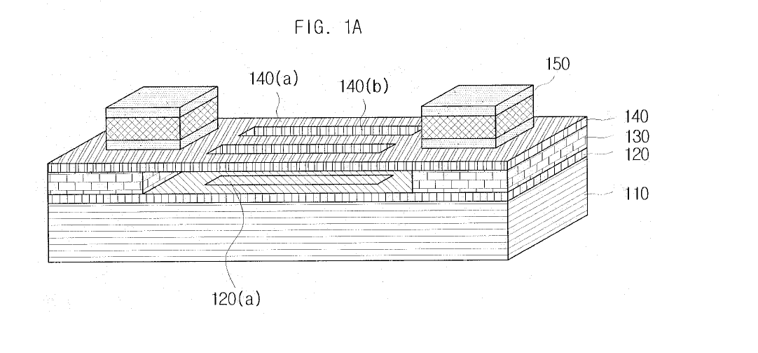

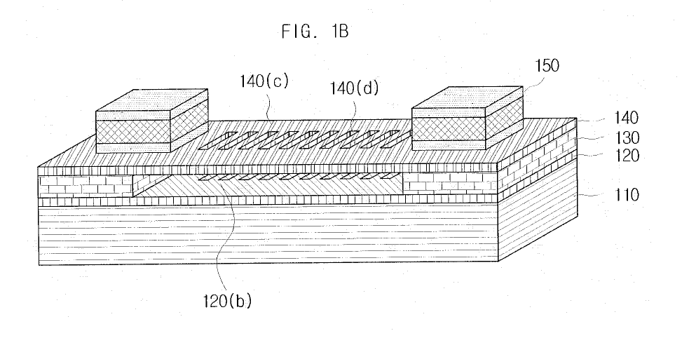

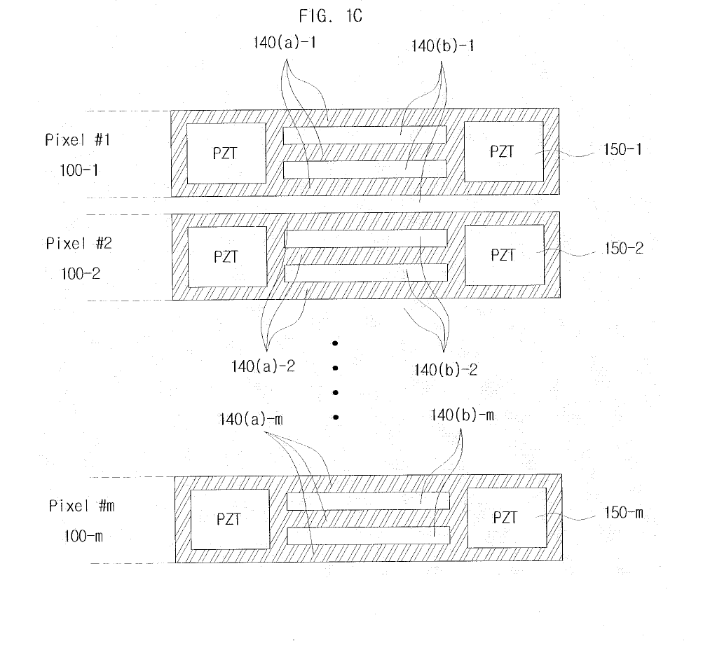

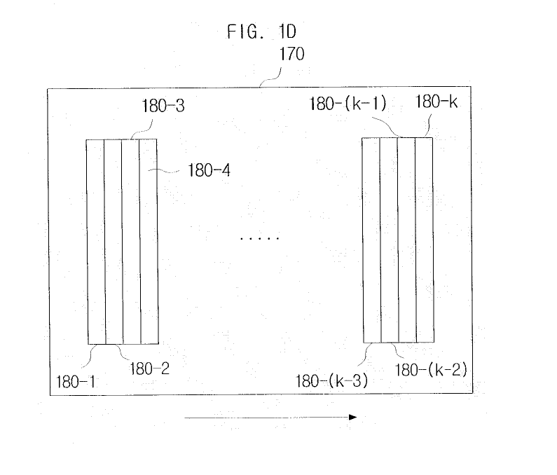

FIG. 1a is a perspective view of a micromirror of a diffraction type optical modulator using a piezoelectric element applicable to an embodiment of the invention, and FIG. 1b is a perspective view of a micromirror of another diffraction type optical modulator using a piezoelectric element applicable to an embodiment of the invention. Referring to FIGS. 1a and 1b, an optical modulator is illustrated which comprises a substrate 110, an insulation layer 120, a sacrificial layer 130, a ribbon structure 140, and piezoelectric elements 150.

The substrate 110 is a generally used semiconductor substrate, while the insulation layer 120 is deposited as an etch stop layer and is formed from a material with a high selectivity to the etchant (the etchant is an etchant gas or an etchant solution) that etches the material used for the sacrificial layer. Here, a reflective layer 120a, 120b may be formed on the insulation layer 120 to reflect incident beams of light.

The sacrificial layer 130 supports the ribbon structure 140 from both sides, such that the ribbon structure 140 may be spaced by a constant gap from the insulation layer 120, and forms a space in the center.

The ribbon structure 140 creates diffraction and interference in the incident light to provide optical modulation of signals as described above. The ribbon structure 140 may be composed of a plurality of ribbon shapes according to the electrostatic type, or may comprise a plurality of open holes 140(b), 140(d) in the center portion of the ribbons according to the piezoelectric type. The piezoelectric elements 150 control the ribbon structure 140 to move vertically, according to the degree of up/down or left/right contraction or expansion generated by the difference in voltage between the upper and lower electrodes. Here, the reflective layers 120(a), 120(b) are formed in correspondence with the holes 140(b), 140(d) formed in the ribbon structure 140.

For example, in the case where the wavelength of a beam of light is λ, when there is no power supplied or when there is a predetermined amount of power supplied, the gap between an upper reflective layer 140(a), 140(c) formed on the ribbon structure and the insulation layer 120, on which is formed a lower reflective layer 120(a), 120(b), is equal to (2n)λ/4 (wherein n is a natural number). Therefore, in the case of a 0-order diffracted (reflected) beam of light, the overall path length difference between the light reflected by the upper reflective layer 140(a), 140(c) formed on the ribbon structure and the light reflected by the lower reflective layer 120(a), 120(b) is equal to nλ, so that constructive interference occurs and the diffracted light is rendered its maximum luminosity. In the case of +1 or −1 order diffracted light, however, the luminosity of the light is at its minimum value due to destructive interference.

Also, when an appropriate amount of power is supplied to the piezoelectric elements 150, other than the supplied power mentioned above, the gap between the upper reflective layer 140(a), 140(c) formed on the ribbon structure and the insulation layer 120, on which is formed the lower reflective layer 120(a), 120(b), becomes (2n+1)λ/4 (wherein n is a natural number). Therefore, in the case of a 0-order diffracted (reflected) beam of light, the overall path length difference between the light reflected by the upper reflective layer 140(a), 140(c) formed on the ribbon structure and the light reflected by the insulation layer 120 is equal to (2n+1)λ/2, so that destructive interference occurs, and the diffracted light is rendered its minimum luminosity. In the case of +1 or −1 order diffracted light, however, the luminosity of the light is at its maximum value due to constructive interference. As a result of such interference, the optical modulator can load signals on the beams of light by controlling the quantity of the reflected or diffracted light.

While the foregoing describes the cases in which the gap between the ribbon structure 240 and the insulation layer 120, on which is formed the lower reflective layer 120(a), 120(b), is (2n)λ/4 or (2n+1)λ/4, it is obvious that a variety of embodiments may be applied with regards the present invention which are operated with gaps that allow the control of the interference by diffraction and reflection.

The descriptions below will focus on the type of micromirror illustrated in FIG. 1a described above.

And, 0-order diffracted (reflected) light, +n order diffracted light, and −n order diffracted light (wherein n is a natural number) will all be referred to as modulated light.

FIG. 1c is a plan view of an optical modulator containing a plurality of micromirrors illustrated in FIG. 1a.

Referring to FIG. 1c, the optical modulator is composed of an m number of micromirrors 100-1, 100-2, . . . , 100-m, each responsible for pixel #1, pixel #2, . . . , pixel #m. The optical modulator deals with image information with respect to 1-dimensional images of vertical or horizontal scanning lines (Here, it is assumed that a vertical or horizontal scanning line consists of an m number of pixels.), while each micromirror 100-1, 100-2, . . . , 100-m deals with one pixel among the m pixels constituting the vertical or horizontal scanning line.

Thus, the light reflected and diffracted by each micromirror is later projected by an optical scanning device as a 2-dimensional image on a screen. For example, in the case of VGA 640*480 resolution, modulation is performed 640 times on one surface of an optical scanning device (not shown) for 480 vertical pixels, to generate 1 frame of display per surface of the optical scanning device. Here, the optical scanning device may be a polygon mirror, a rotating bar, or a galvano mirror, etc.

While the description below of the principle of optical modulation concentrates on pixel #1, the same may obviously apply to other pixels.

In the present embodiment, it is assumed that the number of holes 140(b)−1 formed in the ribbon structure 140 is two. Because of the two holes 140(b)−1, there are three upper reflective layers 140(a)−1 formed on the upper portion of the ribbon structure 140. On the insulation layer 120, two lower reflective layers are formed in correspondence with the two holes 140(b)−1. Also, there is another lower reflective layer formed on the insulation layer 120 in correspondence with the gap between pixel #1 and pixel #2.

Thus, there are an equal number of upper reflective layers 140(a)−1 and lower reflective layers per pixel, and as discussed with reference to FIG. 1a, it is possible to control the luminosity of the modulated light using 0-order diffracted light or ±1-order diffracted light.

FIG. 1d is a schematic diagram illustrating an image generated on a screen by means of a diffraction type optical modulator array applicable to an embodiment of the present invention.

Illustrated is a display 180-1, 180-2, 180-3, 180-4, . . . , 180-(k−3), 180-(k−2), 180-(k−1), 180-k generated when beams of light reflected and diffracted by an m number of vertically arranged micromirrors 100-1, 100-2, . . . , 100-m are reflected by the optical scanning device and scanned horizontally onto a screen 170. One image frame may be projected with one revolution of the optical scanning device. Here, although the scanning direction is illustrated as being from left to right (the direction of the arrow), it is apparent that images may be scanned in other directions (e.g. in the opposite direction).

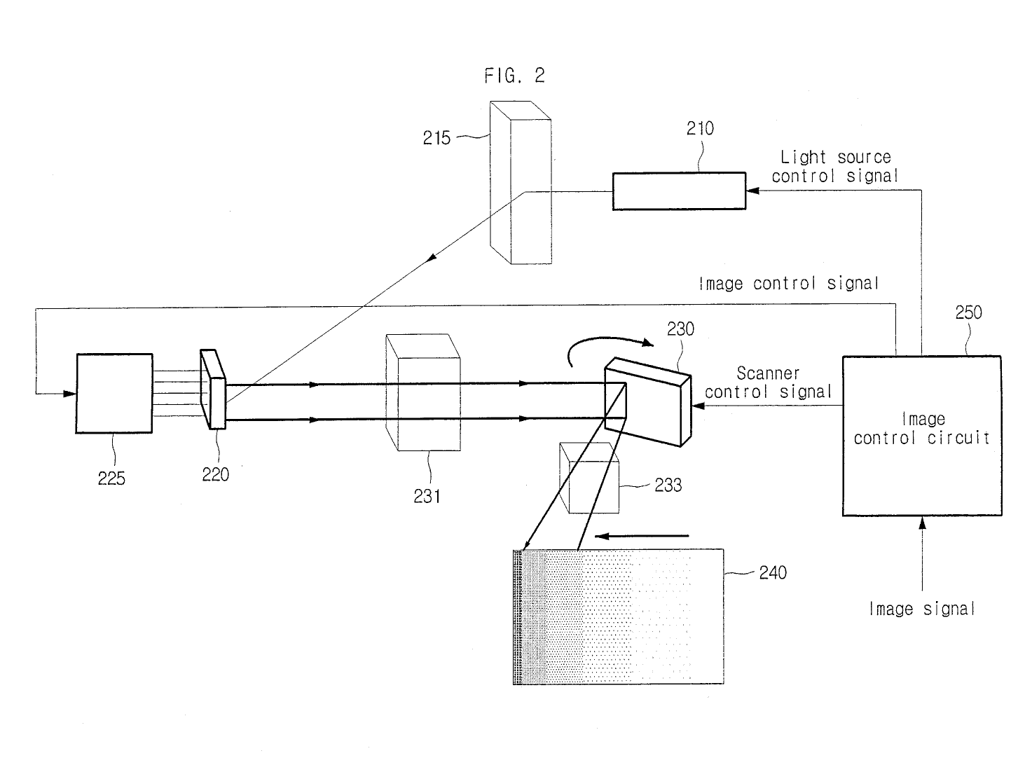

FIG. 2 illustrates a configuration of a display apparatus where a drive characteristic of an optical modulator, in accordance with an embodiment of the present invention, is reflected.

The display apparatus includes a light source 210, an optical modulator 220, a driver integrated circuit (IC) 225, a scanner 230, and an image control circuit 250.

The light source 210 emits light so that an image can be projected on a screen 240. The light source 210 can emit light with white or one of the three primary colors, red, green, and blue.

The light source 210 can be a laser, a light emitting diode (LED), or a laser diode. Here, the white light is separated into the red, green, and blue lights depending on a condition by a color separating unit (not shown).

And, an illumination optical system 215 is equipped between the light source 210 and the optical modulator 220, and can reflect the light emitted from the light source 210 by a designated angle to focus the light onto the optical modulator 220.

When the light is separated by the color separation unit (not shown), a separate function of focusing the light can be possessed in the illumination optical system 215.

The optical modulator 220 modulates the light emitted from the light source 210 in accordance with driving voltage, which is supplied by the driver IC 225, and outputs the modulated light.

The optical modulator 220 is described above referred to FIGS. 1a through 1d, thus, here is omitted the detailed description of it.

The optical modulator 220 is composed of a plurality of micromirrors arrayed in a row, and deals with the one-dimensional images of the vertical or horizontal scanning line in a frame image.

In more detail, the optical modulator 220 outputs modulated light of which brightness is modulated by changing displacement of a micromirror corresponding to each pixel of the one-dimensional image, according to the driving voltage.

The number of the micromirrors may be as many as the pixels composing the vertical or horizontal scanning line.

The modulated light refers to light in which image information of the vertical or horizontal scanning line (that is, a brightness value of each pixel composing the vertical or horizontal scanning line) to be projected later on the screen 240 is reflected, and can be the 0-order diffracted (reflected) light, +n order diffracted light, or −n order diffracted light (wherein n is a natural number).

The driver IC 225 supplies the driving voltage to the optical modulator 220 in order to change the brightness of the modulated light according to image control signals, which is outputted from the image control circuit 250.

A relay optical system 231 transmits the modulated light outputted by the optical modulator 220 to the scanner 230. The relay optical system 231 can include one or more lenses, and controls the modulated light to be appropriate to sizes of the optical modulator 220 and the scanner 230 through adjusting a magnification of the lens, if needed.

The scanner 230 reflects the modulated light, which is inputted from the optical modulator 220, by a designated angle, and then projects that light to the screen 240. Here, the angle is determined by a scanner control signal inputted from the image control circuit 250.

The scanner control signal is synchronized with the image control signal to rotate the scanner 230 with an angle such as the modulated light can be projected onto a position corresponding to the image control signal in the vertical or horizontal scanning line on the screen 240. Examples of the scanner 230 can include a polygon mirror, rotating bar, galvano meter, etc.

A projection optical system 233 includes a projection lens (not shown), and functions such as the modulated light reflected by the scanner 230 is projected on the screen 240.

The image control circuit 250 sends the image control signal, the scanner control signal, and the light source control signal to the driver IC 225, the scanner 230, and the light source 210, respectively.

That is, the image control circuit 250 receives image signals of a frame, and interlocks the image control signal, the scanner control signal, and the light source control signal in accordance with the image signals to control the light source 210, the optical modulator 220, and the scanner 230, thereby displaying the frame image on the screen 240.

In more detail, the image control circuit 250 sends the image control signal to the driver IC 225, in which the image control signal is corresponding to brightness information for each pixel composing the frame, and controls a rotational angle or a rotational speed of the scanner 230 to project the vertical or horizontal scanning line to a predetermined portion on the screen 240 depending on the image control signal.

Below is described drive characteristics of the optical modulator 220.

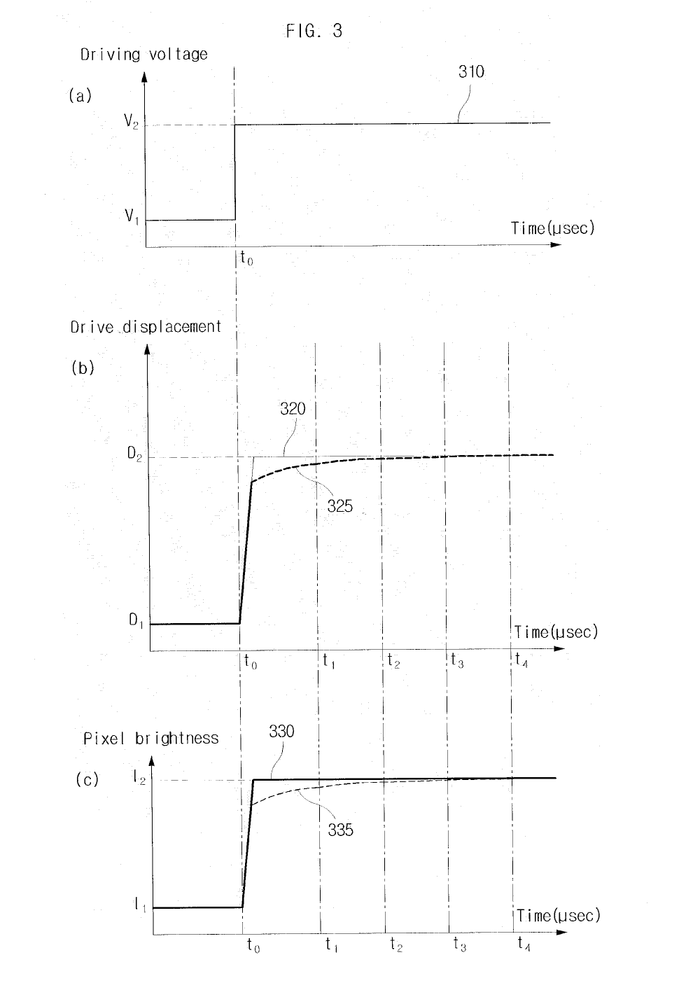

FIG. 3 shows driving voltage supplied to each micromirror of the optical modulator, driving displacement, and brightness of a pixel according to them.

It is assumed that the driving voltage 310 changes from a first voltage V1 to a second voltage V2 at time t0 (referring to FIG. 3(a)).

Referring to FIG. 3(b), ideal driving displacement 320 corresponding to the driving voltage 310 is changed from a first displacement D1 to a second displacement D2 at the t0.

But, the micromirror of the optical modulator 320 is operated according to a response characteristic of the 2nd order system, that is, an overdamp characteristic, which means a Q factor is less than 0.707 (namely, a damping coefficient ζ is greater than 0.707), when the driving voltage is changed from the first voltage to the second voltage.

Thus, practical driving displacement 325 is affected by such a response characteristic of the 2nd order system unlike the ideal driving displacement 320.

So, there is difference between expected brightness and practical brightness in the brightness of the pixel corresponding to each micromirror as shown in FIG. 3(c).

That is, the brightness of pixels is not corresponded to grayscale values of an original image contained in the image signals, thereby causing errors.

Hereinafter is described a process of generating the grayscale values corrected by the image control circuit 250.

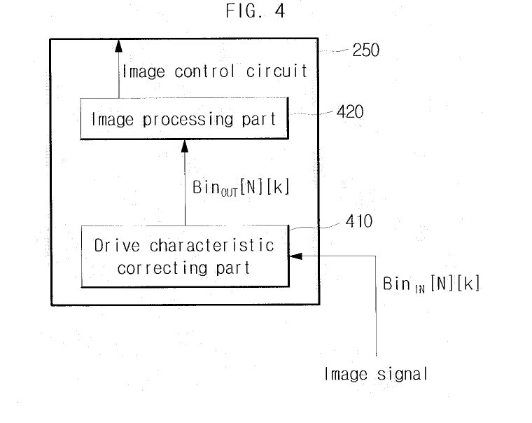

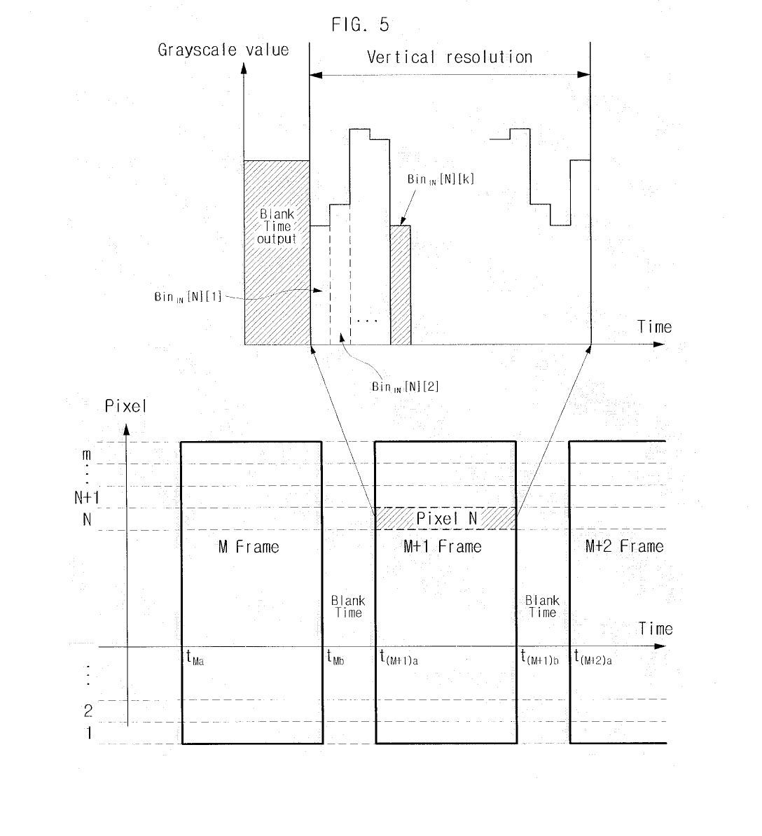

FIG. 4 is a block diagram of the image control circuit 250 according to an embodiment of the present invention, and FIG. 5 shows output timing for displaying the frame image.

The image control circuit 250 includes a drive characteristic correcting part 410, an image processing part 420.

The image control circuit 250 is inputted of the image signal, and generates the image control signal, the light source control signal, and the scanner control signal in correspondence with the inputted image signal, and then sends them to the driver integrated circuit 225, the light source 210, and the scanner 230.

The drive characteristic correcting part 410 generates a corrected grayscale value, reflecting the drive characteristic coefficient according to the drive characteristic of the optical modulator 220 to the original grayscale value of each pixel in the inputted image signal. The optical modulator 220 deals with a one-dimensional image (the vertical or horizontal scanning line), and a two-dimensional frame image may be displayed through scanning of the scanner 230.

The image processing part 420 generates the image control signal that allows each micromirror of the optical modulator 220 to display an image with an expected grayscale according to the inputted image signal.

The relation between the grayscale provided by each micromirror and the driving voltage to be supplied to the micromirror corresponding to the grayscale can be pre-stored in a type of a lookup table.

Namely, the image processing part 420 finds in the lookup table the driving voltage appropriate to provide the grayscale corresponding to the corrected grayscale value generated by the drive characteristic correcting part 410, and then, sends the image control signal to the driver integrated circuit 225 in order that the driving voltage is supplied to the optical modulator 220.

Below are described in detail a principle for compensating the drive characteristic of the micromirror of the optical modulator 220 in the drive characteristic correcting part 410 and a method thereof.

For example, it is assumed the optical modulator 220 deals with the vertical scanning line (containing the m number of pixels), which is scanned in the horizontal direction.

Since the optical modulator 220 projects the one dimensional image, in order to display the two dimensional frame image (M+1 frame), the original grayscale value is changed sequentially during the time as much as the vertical resolution, t(M+1)a−t(M+1)b.

BinIN[N][k] means the original grayscale value that is expected to be projected at a k^{th} pixel time for the horizontal resolution by an N^{th} micromirror (1≦N≦m) of the optical modulator 220.

Here, the pixel time refers to time that corresponds to each pixel in the horizontal resolution in order to display the two dimensional frame image when the one dimensional vertical scanning line is scanned in the horizontal direction.

For example, if the horizontal resolution is 640, 640 pixels are required to provide one frame image.

A corrected grayscale value BinOUT[N][k] is generated by means of the original grayscale values BinIN[N][k], BinIN[N][k−1], BinIN[N][k−2], BinIN[N][k−p−1] (here, p<k), which are provided in the frame image, and the drive characteristic coefficients E0, E1, . . . , Ep with the passage time.

Here, the drive characteristic coefficients E0, E1, . . . , Ep refers to coefficients of the drive characteristic of the optical modulator 220, namely, the drive characteristic of the 2nd order system of the micromirror, and have constant values irrespective of the order(N) of the micromirrors or the order(k) for the horizontal resolution.

The corrected grayscale value BinOUT[N][k] can be calculated by the following Equation 1.

$$BinOUT [ N ] [ k ] = BinIN [ N ] [ k ] + E 0 ( BinIN [ N ] [ k ] - BinIN [ N ] [ k - 1 ] ) + E 1 ( BinIN [ N ] [ k - 1 ] - BinIN [ N ] [ k - 2 ] ) + E 2 ( BinIN [ N ] [ k - 2 ] - BinIN [ N ] [ k - 3 ] ) + … + Ep ( BinIN [ N ] [ k - p ] - BinIN [ N ] [ k - p - 1 ] ) \\ Here , p < k - 1 < E 0 , E 1 , … , Ep < 1 \qquad [ Equation 1 ]$$

Referring to the Equation 1, the corrected grayscale value of the present pixel time, k, is calculated by using the original grayscale values of the previous pixel time k−1, k−2, k−3, . . . , k−p−1 and the drive characteristic coefficients E0, E1, E2, . . . , Ep.

In order that the micromirror outputs desired pixel brightness at the present pixel time k, change in the displacement may be occurred in the driving displacement at the previous pixel time k−1.

At this case, the average pixel brightness during one pixel time can be calculated to be the expected pixel brightness by applying the influence of the drive characteristic of the 2nd order system of the micromirror.

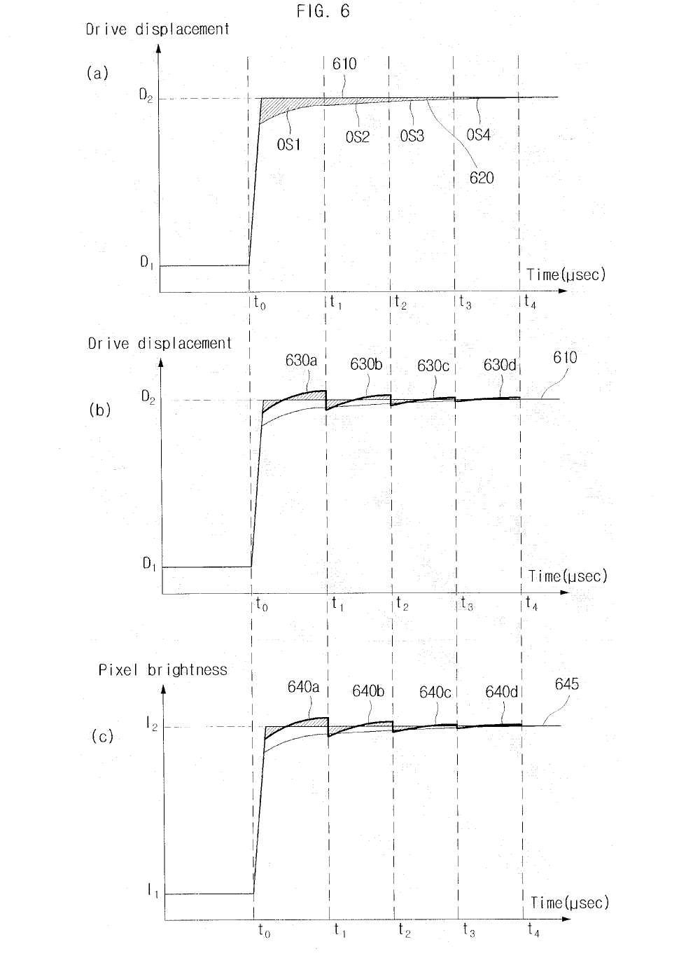

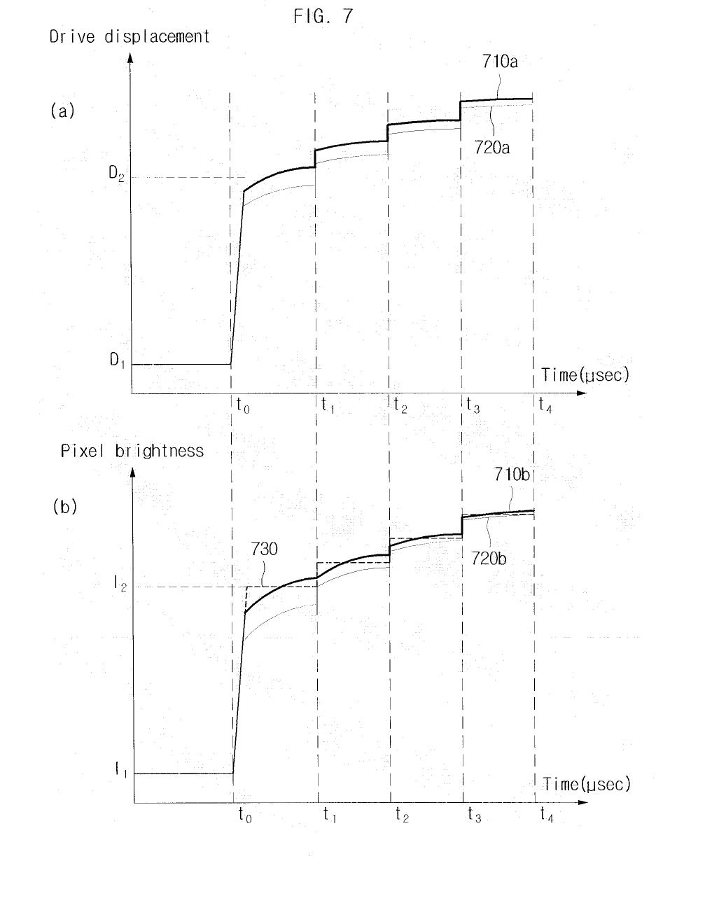

FIG. 6 shows the drive displacement and the pixel brightness in the pixel according to an embodiment of the present invention, and FIG. 7 shows the drive displacement and the pixel brightness in the pixel according to another embodiment of the present invention.

Referring to FIG. 6(a), the micromirror of the optical modulator 220 changes from a first drive displacement D1 to a second drive displacement D2.

Compared to the ideal drive displacement, the practical drive displacement changes with an error OS1, OS2, OS3, and OS4 at each pixel time t0-t1, t1-t2, t2-t3, and t3-t4, respectively. The error may be a value representing the characteristic of the drive displacement.

Therefore, in order to reduce the error and maintain the average pixel brightness in each pixel time t0-t1, t1-t2, t2-t3, and t3-t4 as the expected value, it is required for the displacement of the micromirror to be corrected independently in each pixel time t0-t1, t1-t2, t2-t3, and t3-t4 as shown in FIG. 6(b).

Here, if the corrected grayscale value is calculated in accordance with the Equation 1, the first corrected grayscale value BinOUT[N][1] through the fourth corrected grayscale value BinOUT[N][4] are calculated as shown in the following Equation 2.

$$BinOUT [ N ] [ 1 ] = BinIN [ N ] [ 1 ] + E 0 \times BinIN [ N ] [ 1 ] \\ BinOUT [ N ] [ 2 ] = BinIN [ N ] [ 2 ] + E 0 ( BinIN [ N ] [ 2 ] - BinIN [ N ] [ 1 ] ) + E 1 \times ( BinIN [ N ] [ 1 ] ) \\ BinOUT [ N ] [ 3 ] = BinIN [ N ] [ 3 ] + E 0 ( BinIN [ N ] [ 3 ] - BinIN [ N ] [ 2 ] ) + E 1 ( BinIN [ N ] [ 2 ] - BinIN [ N ] [ 1 ] ) + E 2 \times ( BinIN [ N ] [ 1 ] ) \\ BinOUT [ N ] [ 4 ] = BinIN [ N ] [ 4 ] + E 0 ( BinIN [ N ] [ 4 ] - BinIN [ N ] [ 3 ] ) + E 1 ( BinIN [ N ] [ 3 ] - BinIN [ N ] [ 2 ] ) + E 2 ( BinIN [ N ] [ 2 ] - BinIN [ N ] [ 1 ] ) + E 3 \times ( BinIN [ N ] [ 1 ] ) \qquad [ Equation 2 ]$$

The first corrected grayscale value BinOUT[N][1] is obtained by adding the original grayscale value at the present pixel time BinIN[N][1], difference between the original grayscale values at the present pixel time BinIN[N][1] and at the previous pixel time BinIN[N][0]=0, and the value reflecting the drive characteristic.

Here, since the original grayscale value at the previous pixel time is 0, the first drive characteristic coefficient E0 corresponding to the first error OS1 in FIG. 6(a) is reflected only to the original grayscale value at the present pixel time BinIN[N][1].

The second corrected grayscale value BinOUT[N][2] is determined by the original grayscale value at the present pixel time BinIN[N][2] and the original grayscale value at the previous pixel time BinIN[N][1] and BinIN[N][0].

Here are added the original grayscale value at the present pixel time BinIN[N][2], the value reflecting the first drive characteristic coefficient E0 with the difference between the original grayscale values at the present pixel time BinIN[N][2] and the original grayscale values at the previous pixel time, and the value reflecting the second drive characteristic coefficient E1 with the difference between the original grayscale values at the previous pixel time BinIN[N][1] and the original grayscale values at the one more previous pixel time BinIN[N][0].

That means, the original grayscale value BinIN[N][0] at the one more previous pixel time is reflected by the third error OS3 since already two pixel times are past, and, the original grayscale value BinIN[N][1] at the previous pixel time is reflected by the second error OS2 since one pixel time is past, as shown in FIG. 6(a).

Here, since the micromirror in each pixel time is driven not at an initial position, but at the position of the previous pixel time, the drive characteristic coefficient is reflected to the difference between the original grayscale value at the present pixel time and the original grayscale value at the previous pixel time.

Therefore, referring to FIGS. 6(b) and (c), the drive displacements 630a, 630b, 630c, and 630d of the micromirror appear in separate shapes for each pixel time although the pixel brightness is expected to be I₂ for all the pixel time.

The pixel brightness 640a, 640b, 640c, and 640d is formed in the same shape as the drive displacement 630a, 630b, 630c, and 630d at each pixel time respectively, and it is can be seen that the average pixel brightness is to be the expected value I₂.

FIGS. 7(a) and (b) show the drive displacement 720a and the pixel brightness 720b before the correction is conducted by reflecting the drive characteristic coefficient, and the drive displacement 710a and the pixel brightness 710b after the correction is conducted by reflecting the drive characteristic coefficient when the expected value of the pixel brightness is changed as the pixel time passes, according to an embodiment of the present invention.

In the case of reflecting the drive characteristic coefficient, the pixel brightness 710b for each pixel time has the average value equal to or near the expected value 730.

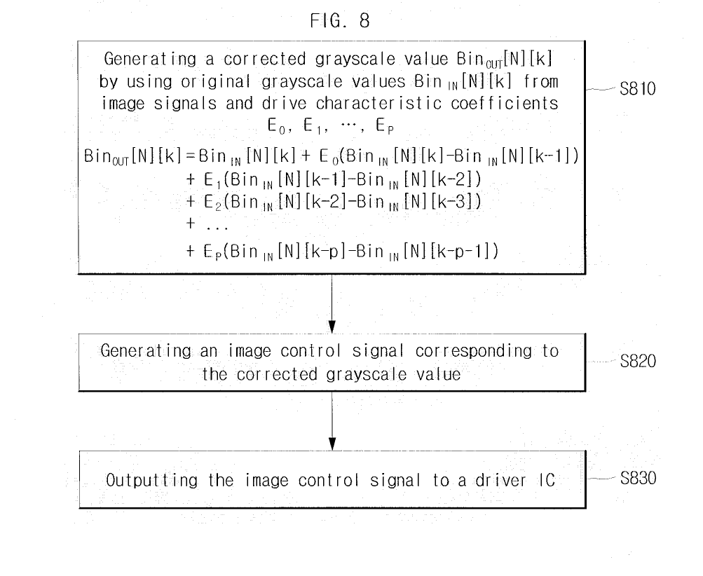

FIG. 8 is a flowchart illustrating a method of image-controlling in an image control circuit according to an embodiment of the present invention. The image control circuit 250 includes the drive characteristic correcting part 410 and the image processing part 420.

At the step S810, the drive characteristic correcting part 410 generates a corrected grayscale value by using the original grayscale value extracted from the inputted image signal and the drive characteristic coefficient depending on the drive characteristic of the optical modulator 220. The principle and the method for generating the corrected grayscale value are described above referring to FIGS. 5 through 7 so as to be omitted here.

At the step S820, the image processing part 420 generates the image control signal in order to allow the modulated light from the optical modulator 220 to have the brightness corresponding to the corrected grayscale value provided by the drive characteristic correcting part 410, and also does the light source control signal and the scanner control signal interlocking with the image control signal.

At the step S830, the image control circuit 250 sends the image control signal to the driver integrated circuit 225, the light source control signal to the light source 210, and the scanner control circuit to the scanner 230.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A display apparatus comprising:
an optical modulator that modulates brightness of the incident light from a light source corresponding to a driving voltage and outputs the modulated light;
a driver integrated circuit that supplies a driving voltage according to an image control signal to the optical modulator;
a scanner that projects the modulated light to a position on a screen; and
an image control circuit that generates and outputs the image control signal from an input image signal for reducing influence of drive characteristics of the optical modulator.

2. The apparatus of claim 1, wherein the image control circuit comprises:
a drive characteristic correcting part that outputs a corrected grayscale value where an original grayscale value from the input image signal and a drive characteristic coefficient of the optical modulator are reflected; and
an image processing part that outputs to the driver integrated circuit the image control signal in order to project the modulated light with brightness corresponding to the corrected grayscale value, the image control signal configured to supply the driving voltage predetermined by a lookup table including relation between the driving voltage and the brightness to the optical modulator.

3. The apparatus of claim 2, wherein the drive characteristic correcting part determines the corrected grayscale value by using the original grayscale value at a present pixel time, the original grayscale values at previous pixel times, and a drive characteristic coefficient of the optical modulator with the passage of time.

4. The apparatus of claim 3, wherein the drive characteristic coefficient is a constant value for all pixels.

5. The apparatus of claim 3, wherein the corrected grayscale value is calculated by the following Equation 1.
BinOUT[N][k]=BinIN[N][k]+E0×(BinIN[N][k]−BinIN[N][k−1])+E1×(BinIN[N][k−1]−BinIN[N][k−2])+ . . . +Ep×(BinIN[N][k−p]−BinIN[N][k−p−1])−Here, BinOUT[N][k] is the corrected grayscale value, BinIN[N][k] is the original grayscale value, N is a position of the pixel, k is the present pixel time, p<k, E0, E1, . . . , Ep is the drive characteristic coefficient between −1 and 1−. [Equation 1]

6. The apparatus of claim 2, wherein the modulated light of the optical modulator according to the corrected grayscale value has average brightness corresponding to the original grayscale value during one pixel time.

7. An image control method for minimizing influence of drive characteristics of an optical modulator in a display apparatus which includes the optical modulator that modulates brightness of incident light from the light source according to inputted driving voltage and outputs the modulated light, and a driver integrated circuit that provides to the optical modulator driving voltage corresponding to a image control signal, the method comprising:
generating a corrected grayscale value by using an original grayscale value extracted from an inputted image signal and a drive characteristic coefficient according to the drive characteristics of the optical modulator;
generating an image control signal for allowing the modulated light to have brightness corresponding to the corrected grayscale value; and
outputting the image control signal to the driver integrated circuit.

8. The method of claim 7, wherein in the generating the corrected grayscale value, the corrected grayscale value is determined by using an original grayscale value at a present pixel time and an original grayscale values at previous pixel times, and a drive characteristic coefficient of the optical modulator with the passage of time.

9. The method of claim 8, wherein the corrected grayscale value is calculated by the following Equation 2.
BinOUT[N][k]=BinIN[N][k]+E0×(BinIN[N][k]−BinIN[N][k−1])+E1×(BinIN[N][k−1]−BinIN[N][k−2])+ . . . +Ep×(BinIN[N][k−p]−BinIN[N][k−p−1])−Here, BinOUT[N][k] is the corrected grayscale value, BinIN[N][k] is the original grayscale value, N is a position of the pixel, k is the present pixel time, p<k, E0, E1, . . . , Ep is the drive characteristic coefficient between −1 and 1−. [Equation 2]
